(19) United States
(12) Patent Application Publication
(10) Pub. No.: US 2001/0030662 A1
(43) Pub. Date: Oct. 18, 2001

(54) System and method for displaying index information on a computer screen

(76) Inventors: Toshihiko Ohkawa, Yokohama (JP); Hironori Ishli, Tokyo (JP)

Correspondence Address: Finnegan, Henderson, Farabow, Garrett & Dunner, L.L.P., 1300 I Street, N.W., Washington, DC, 20005-3315, US

(21) Appl. No.: 09/879,051

(22) Filed: Jun. 13, 2001

Related U.S. Application Data
(63) Continuation-in-part of application No. 09/467,634, filed on Dec. 20, 1999.

(30) Foreign Application Priority Data
Jun. 14, 2000 (JP) 2000-177867

(51) Int. Cl. G06F 3/14

(52) U.S. Cl. 345/764; 345/853

(57) ABSTRACT

A system for displaying index information includes: hierarchy/correlation data device; a meta data storage device; a syntax analysis device; a graphic image rendering device; and a display device. A multi-level information index display method includes the steps of: setting and editing multi-level hierarchical and correlated information; storing the information as meta data; analyzing the meta data and generating a set of rendering instructions; rendering a graphic image based on the analyzed meta data and set of rendering instructions; and displaying the graphic image on a computer screen for user to view. A method for displaying an item among a group of items to users includes the steps of: setting and editing multi-level hierarchical and correlated information of each of the group of items; storing the information as meta data; analyzing the meta data and generating a set of rendering instructions; rendering a graphic image based on the analyzed meta data and set of rendering instructions; and displaying the graphic image for each of the group of items for a user to view. These system and methods allow users to appreciate the entire display information and access desired content information efficiently.

### CROSS REFERENCE TO RELATED APPLICATION

This application is related to and claims rights under 35 U.S.C. §120 in copending U.S. patent application Ser. No. 09/467,634, entitled “Compound Computer Screen Icon,” filed Dec. 20, 1999, the entire disclosure of which is expressly incorporated herein by reference. Also, this application is related to and claims rights under 35 U.S.C. §119(a) in Japanese Patent Application 2000-177867, filed Jun. 14, 2000, the entire disclosure of which is expressly incorporated herein by reference.

### BACKGROUND OF THE INVENTION

1. Field of the Invention

The present invention relates to a system and method for displaying index information on a computer screen. More particularly, the invention pertains to a system and method that provides users with an index information display on a computer screen, such as compound computer screen icons or information.

2. Description of the Related Art

There are many systems or computer screen displays that display index and content information as a hierarchical model. In those systems, a computer screen display generally displays index information in a hierarchical structure. Even if information to be displayed does not initially have a hierarchical structure, a user may benefit from an information display with a hierarchical structure when a group of information is to be displayed simultaneously in its entirety. FIG. 13 illustrates an exemplary diagram of an information display having a hierarchical structure. As shown in FIG. 13(a), index information “Title 1,” “Title 2,” “Title 3,” or “Title 4” has the highest hierarchical level in the display. Subtitles accompany each of those index information (except “Title 3”) as index information having a lower hierarchical level, and items are displayed below the subtitles with even a lower hierarchical level. The titles may include content information; however, the items ordinarily are those that include the content information in detail.

When the display information is large, the limited display area of a computer screen may not be able to display the entire display information. Under those circumstances, only a part of the information display is selected and displayed as illustrated in FIG. 13(b). Alternatively, only the index information at the highest hierarchical level may be displayed, as shown in FIG. 13(c). Because the user cannot view the entire display from these partial displays, the user needs to operate a device, such as a mouse, to track desired content information located at a different hierarchical level.

In conventional display systems, therefore, the user needs to search or roam from index information at different hierarchical levels to obtain desired content information. As the display information and index information become larger, the operation by the user to track the desired content information becomes more time-consuming and even more complex. Consequently, there has been a need for more efficient method and system for displaying index information to obtain desired content information from display information.

### SUMMARY OF THE INVENTION

One object of the invention is to provide a method and system for displaying index information that alleviates the above-mentioned problems associated with the conventional approaches. The present invention provides a method and system that allows users to appreciate the entire display information and also access desired content information efficiently.

Another object of the invention is to provide a method for providing an item among a group of items that allows customers to appreciate the entire display information or items and to access desired content information or items efficiently.

Additional objects and advantages of the invention will be set forth in part in the description which follows, and in part will be obvious from the description, or may be learned by practice of the invention. The advantages and purpose of the invention will be realized and attained by the elements and combinations particularly pointed out in the appended claims.

To attain the advantages and in accordance with the purposes of the invention, as embodied and broadly described herein, the invention is directed to a system for displaying index information, including: a hierarchy/correlation data device for setting and editing hierarchy and correlation data; a meta data storage device for storing the edited and set index information as meta data; a syntax analysis device for analyzing the meta data and generating a set of rendering instructions; a graphic image rendering device for rendering a graphic image based on the analyzed meta data and set of rendering instructions; and a display device for displaying the rendered graphic image.

According to another aspect of the invention, the objects and advantages of the invention are attained by a multi-level information index display method, including the steps of: setting and editing multi-level hierarchical and correlated information; storing the information as meta data; analyzing the meta data and generating a set of rendering instructions; rendering a graphic image based on the analyzed meta data and set of rendering instructions; and displaying the graphic image on a computer screen for user to view.

Yet another aspect of the invention, a method for displaying an item among a group of items to users, includes the steps of: setting and editing multi-level hierarchical and correlated information of each of the group of items; storing the information as meta data; analyzing the meta data and generating a set of rendering instructions; rendering a graphic image based on the analyzed meta data and set of rendering instructions; and displaying the graphic image for each of the group of items for a user to view.

Still another aspect of the invention, a method for displaying a graphic image, having the steps of: setting meta data to information, the meta data including hierarchical and correlated information; analyzing the information having the meta data; and rendering the graphic image based on the analyzed meta data, the graphic image having a graphic effect according to the hierarchical and correlated information.

Yet another aspect of the invention, a method for displaying graphic images in a hierarchical and correlated manner, including the steps of: setting meta data to information, the meta data being an index information to display the information in a hierarchical and correlated relationship; analyzing the information having the meta data; rendering the graphic images in the hierarchical and correlated relationship based on the analyzed meta data; and displaying the graphic images in the hierarchical and correlated relationship for users to view the graphic images collectively.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one several embodiments of the invention and together with the description, serve to explain the principles of the invention. In the drawings:

FIG. 1 is a schematic drawing depicting an example of an index information display method according to the present invention;

FIG. 2 is a block diagram of an exemplary index information display system according to the present invention;

FIG. 3 is a block diagram of an exemplary index information display system according to present invention;

FIG. 4 is a flow chart illustrating one exemplary operation procedure of an index information display method for searching a music compact disc (CD) according to an embodiment of the present invention;

FIG. 5 is an exemplary screen display of an index information display system according to an embodiment of the invention;

FIG. 6 is a zoomed screen display of FIG. 5;

FIG. 7 is a zoomed screen display of FIG. 6;

FIG. 8 is a screen display of a listening screen according to an embodiment of the present invention;

FIG. 9 is an exemplary flow chart of the operation of an index display method for searching a music CD according to an embodiment of the invention;

FIG. 10 is an exemplary screen display of an index information display system according to an embodiment of the invention;

FIG. 11 is a zoomed screen display of FIG. 10;

FIG. 12 is a zoomed screen display of FIG. 11; and

FIG. 13(a), 13(b) and 13(c) illustrate a conventional information displays having hierarchical structures.

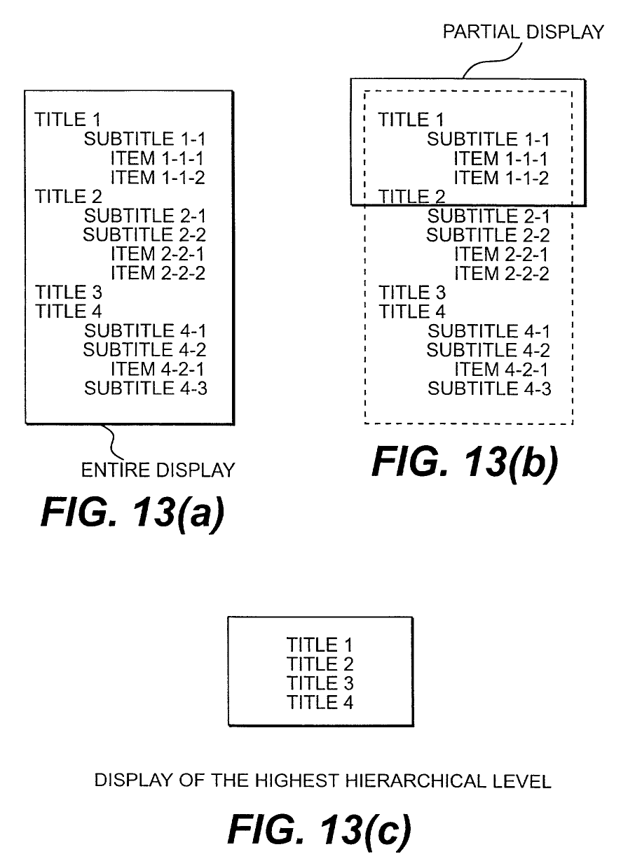

### DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

In accordance with an aspect of the invention, a system for displaying index information includes: a hierarchy/correlation data device for setting and editing hierarchy data and correlation data; a meta data storage device for storing the edited and set index information as meta data; a syntax analysis device for analyzing the meta data and generating a set of rendering instructions; a graphic image rendering device for rendering a graphic image based on the analyzed meta data and set of rendering instructions; and a display device for displaying the rendered graphic image.

In another aspect of the invention, a multi-level information index display method includes the steps of: setting and editing multi-level hierarchical and correlated information; storing the information as meta data; analyzing the meta data and generating a set of rendering instructions; rendering a graphic image based on the analyzed meta data and set of rendering instructions; and displaying the graphic image on a computer screen for user to view.

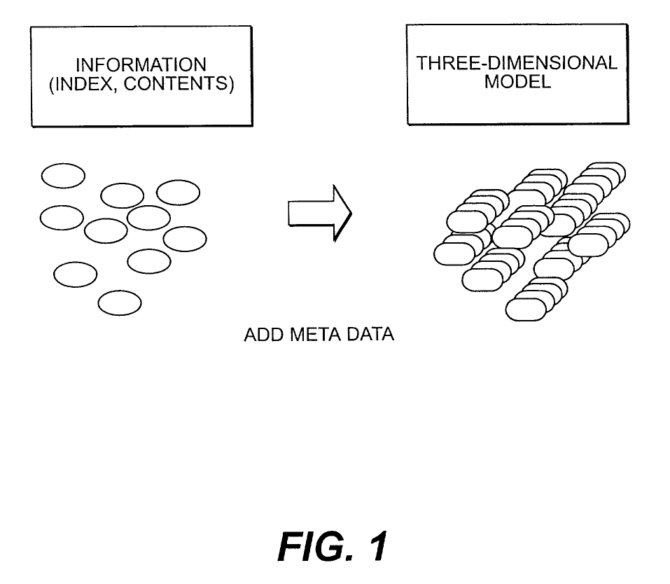

As shown in FIG. 1, index information and content information can be displayed two-dimensionally. However, by setting multi-level hierarchical and correlated information as meta data and rendering a graphic image based on the meta data, the index and content information can be displayed in hierarchical and correlated manner, for example, using a three-dimensional model. As a result, the entire index information can be simultaneously displayed in hierarchical and correlative manner. Users can view the entire information and appreciate the hierarchical and correlative relationship among the index information, and readily search index information and locate desired content information.

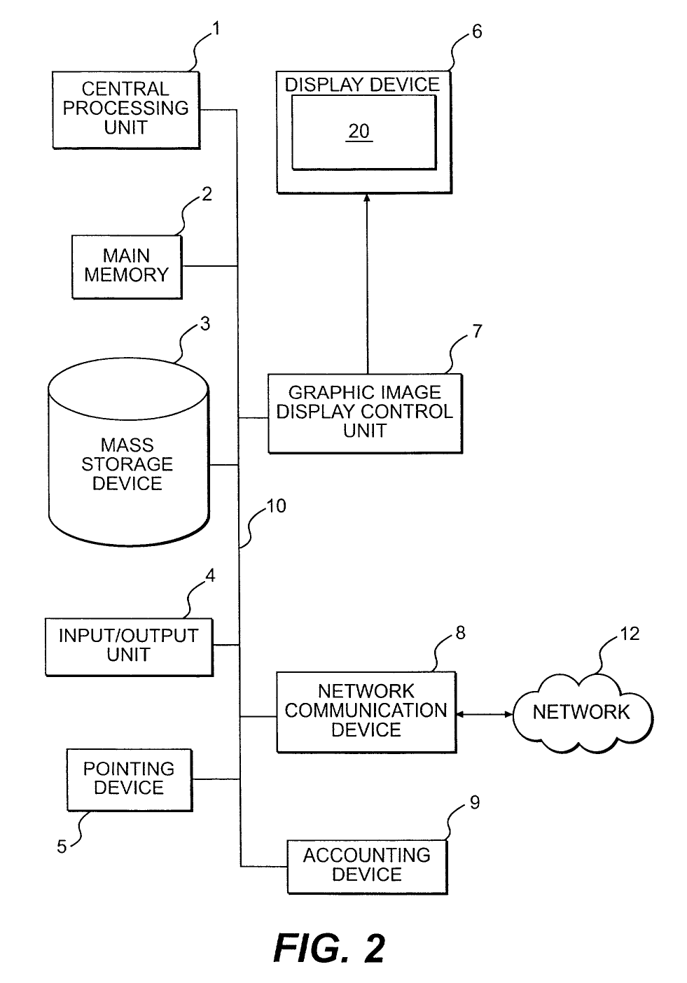

The index information display system of FIG. 2 may be a computer-based system capable of executing a method for displaying index information. In general, the system includes a central processing unit (CPU) 1, a main memory 2, a mass storage device (a hard-disk drive or the like) 3, an input/output unit (a printer, a keyboard or the like) 4, a pointing device 5, a display device (CRT, LCD or the like) 6, and a graphic image display control unit 7. A common data bus 10 connects each of the devices. Preferably, the system should also include a network communication device 8 and an accounting device 9 that are connected to data bus 10. Network communication device 8 serves as an interface with the Internet or other networks 12, and accounting device 9 may handle billing and invoice tasks. Network 12 is preferably connected to multiple users 14A, 14B . . . 14N, and each user can access the system remotely via network 12 to view the index or content information. The operation and features of the system of FIG. 2 will become more readily apparent from the description of the following embodiments.

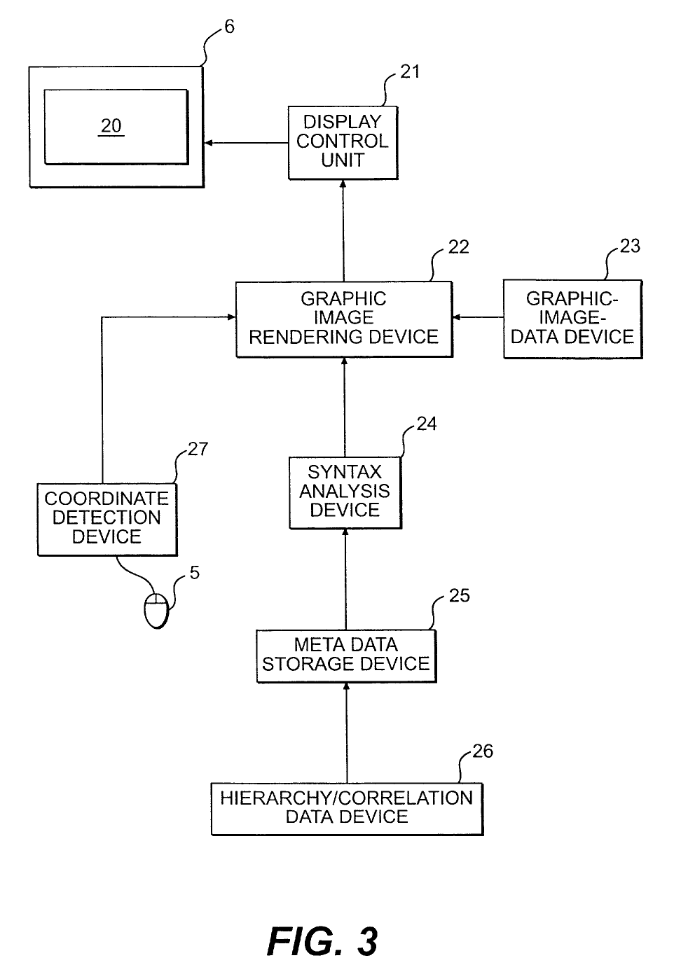

FIG. 3 illustrates an exemplary index information display system. As shown in FIG. 3, the system includes a hierarchy/correlation data setting-editing component 26 for setting and editing hierarchy and correlation data; a meta data storage component 25 for storing the edited and set index information as meta data; a syntax analysis component 24 for analyzing the meta data and generating a set of rendering instructions; a graphic image rendering component 22 for rendering a graphic image based on the analyzed meta data and set of rendering instructions; and a display control unit 21 and display device 6 for displaying the rendered graphic image. Each of these components may be implemented by any suitable combination of hardware, software, and/or firmware.

The index information display system shown in FIG. 3 may be implemented as a part of the system environment illustrated in FIG. 2. The components of the index information display system in FIG. 3 may be implemented, for example, a part of graphic image display control unit 7, main memory 2, mass storage device 3, and/or any other device of the system shown in FIG. 2. The index information display system in FIG. 3 may utilize some of the devices shown in FIG. 2. For example, pointing device 5 and display device 6 are used with the index information display system in FIG. 3.

In general, meta data includes information related to object or category names, hierarchy/correlation data, three-dimensional coordinates, and location data. The object or category names include the name of the data to be displayed on display device 6, such as a music title, Symphony_No5, in case of compact disk jacket data. The hierarchy/correlation data defines the hierarchy or correlation of the data by identifying upper and/or lower hierarchical data, such as a composer of the music, Mahlar. In the example of the compact disk jacket data, the hierarchy/correlation data of “Symphony_No5” data indicates that it belongs to a hierarchical group under “Mahlar.”

The three-dimensional coordinate of the data identifies the location of the data on the display screen in a three-dimensional manner. The location data identifies the location of the data, such as a URL address in the Internet or a pointer in a computer. A more specific example of the meta data will be described later in the specification.

In hierarchy/correlation data setting-editing component 26, hierarchical and correlation data for index and content information to be displayed is set or edited. For example, some index information may be set or edited as titles, which have the highest hierarchical level among index and content information to be displayed. Hierarchical data and correlation data for subtitles and items corresponding to each of the titles are also set and edited by hierarchy/correlation data setting-editing component 26. Hierarchy/correlation data setting-editing component 26 sets or edits hierarchical relationships among the index and content information so that the index and content information can be expressed by spatial distance, brightness, chroma or size differences that correspond to the hierarchical relationships of the information. The hierarchical relationships may be expressed in three-dimension or in two-dimension with another hierarchical indication, such as shadowing.

These hierarchy/correlation data may be set or edited simply by typing in the data by input unit 4 (such as a key board), using pointing device 5, and/or using any other suitable input device. Once the hierarchy/correlation data is set or edited for the content information. The index information display system recognizes the hierarchy/correlation data and the corresponding content data.

The hierarchical and correlation data set or edited by hierarchy/correlation data setting-editing component 26 is stored in meta data storage component 24. In this embodiment, hierarchy data may be stored separately from the content information. However, the corresponding content data stored at some other location in a storage device should be easily identified by the meta data. Meta data storage component 24 may be a memory device, such as a hard-disk drive or a semi-conductor chip, in a computer system.

Syntax analysis component 24 analyzes the hierarchical and correlation data stored in meta data storage component 24. Syntax analysis component 24 interprets the meta data and generates a set of rendering instruction to graphic image rendering component 22. The syntax analysis performed by syntax analysis component 24 determines for each data, for example, whether a three-dimensional shading process should be performed on the data, whether an image synthesis process should be performed, and in what order its graphic image should be rendered. The shading process or any other graphic effects are mathematically determined from the meta data.

The syntax analysis may also include determination of how much shading or other graphic effects should be used based on the hierarchical and correlation data. For example, data having the highest hierarchy is instructed to have the brightest display, and data having the lowest hierarchy is instructed to have the darkest display with greater shading effects. Other data that belong within the hierarchy may be shaded based on their relative hierarchical position between the highest and lowest hierarchies. Syntax analysis component 24 subsequently generates a set of rendering instructions and those instructions are provided as input to graphic image rendering component 22.

In a preferred embodiment of the invention, the index information display system of FIG. 3 includes a data storage device 23 coupled to graphic image rendering component 22. Data storage device 23 contains data for rendering graphic images including, for instance, jacket geometry data or graphic image patterns for a compact disk (CD) and other data necessary for rendering a graphical image. The graphic image data also includes graphic symbols and patterns of a jacket or other objects.

Graphic image rendering component 22 retrieves necessary data for rendering a graphic image in accordance with the rendering instructions from syntax analysis component 24, and creates a graphic image to be displayed. Graphic image rendering component 22 converts the meta data into a graphic image based on the rendering instructions and graphic image rendering data, such as structures, shapes, surfaces attributes, designs and graphic patterns, movements or the like. Preferably, graphic image rendering component 22 can create a graphic image by animating a series of rendering instructions. As described above, graphic image rendering component 22 expresses the hierarchy and correlation by a group of index information graphic images, and renders graphic images having different brightness, chroma and sizes in a three-dimensional shading model or any other three-dimensional computer graphics.

Consequently, the index information display device structure allows users to simultaneously view the entire index information to appreciate hierarchical and correlative relationships among the information at glance. The relationship among the information is conceptually displayed by a three-dimensional position, for example. The information having similar characters may be displayed close to each other from right to left on the display screen. Moreover, when the information belongs to similar categories, the information may be displayed from the front to the back on the display (different depths on the screen display). By repeatedly utilizing these displays, users can readily understand the relationships of the index information.

In the embodiment of FIG. 3, the index information system includes a coordinate detection component 27 connected to graphic image rendering component 22. Coordinate detection component 27 is equipped with mouse 5 or any other similar component and sets a coordinate or location of a graphic image at a display screen. For example, the user may drag a created graphic image by mouse 5 and release the image at the desired display location.

The index information display system preferably has a display control unit 21 connected to graphic image rendering component 22 and display component 6. Display control unit 21 controls signals from graphic image rendering component 22 and causes a graphic image to be displayed on a display screen 20 of display component 6.

The aforementioned index information display system, therefore, can collectively display the entire images of the index information with their hierarchical and correlative relationships. These hierarchical and correlative relationships if the images are indicated by spatial distance, brightness, chrome or size differences in the displayed graphic image. The user can access the content data typically located at the lowest hierarchical level by accessing these graphic images of index information.

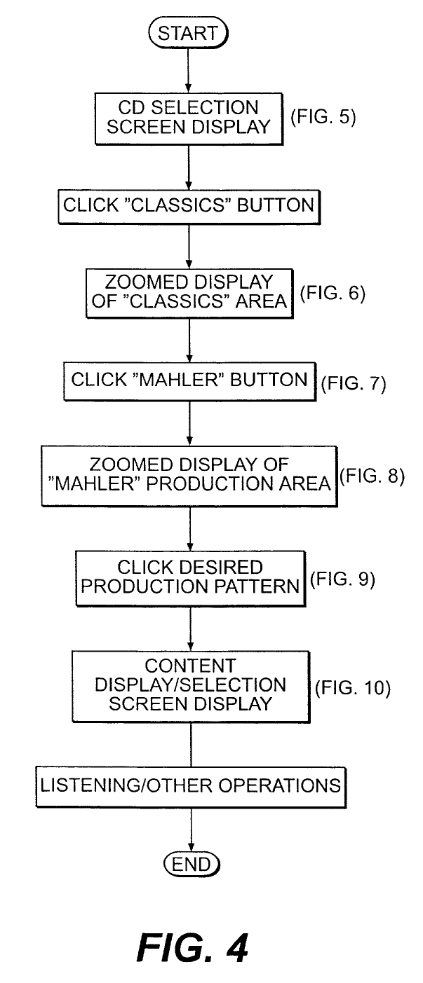

An exemplary embodiment of the index information display system will now be described with reference to FIGS. 4-12. This embodiment is directed to an index information display system related to music CDs.

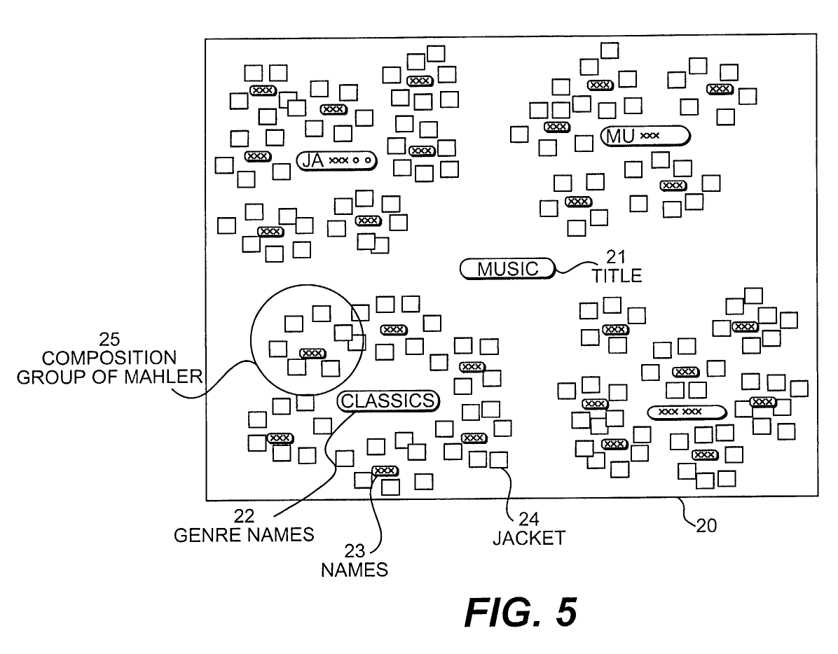

FIG. 4 illustrates an exemplary flow chart of an operation procedure of an embodiment of the index information display system and method for searching a music CD, and FIGS. 5-7 illustrate a graphic display in accordance with the system and method. As shown in FIGS. 4 and 5, a search for a music CD starts from a display of a CD selection screen 20 (Step S.40). In this embodiment, titles are displayed as bars or tree branches 22a-c across selection screen 20. For example, title bar 22a is categorized as “CLASSICS.” Each of title bars has a plurality of music genre names 22b-c. In the vicinity of each genre name 22b-c, a plurality of CD jacket graphic images 24 and composer's names 23, and music titles may be displayed as a composition group 25 of the composer. In this embodiment, these CD jacket graphic images and composer's names may resemble leaves on bars or tree branches 22a-c. In one preferred embodiment, composition groups 25 may be arranged so that ones having similar style of music are located close to each other. Such arrangement can be achieved by defining meta data accordingly.

Selection screen 20 may also include an operation button 26 that is selected or controlled by a user (for example, with a mouse) to control the relative position of bars 22a-c, and a window 27 for displaying the operation selected through operation button 26. Operation button 26 may be provided with a “Forward” button for moving the title bar to the front side, a “Backward” button for moving the title bar to the back, “ZoomIn” and “ZoomOut” buttons for zooming in or zooming out the display, an “Up” button and a “Low” button for moving the display up and down, and any buttons necessary for other display screen operations. Operation button 26 makes earlier to move between different hierarchical levels and facilitates the search for a desired CD.

Similar to the embodiment previously described, CD jacket graphic images 24 of this embodiment may be displayed according to the order of popularity or in the chronological order. For example, CD jacket graphic images 24 may be displayed, according to their popularity, toward the back of the display screen view.

In FIG. 5, the level of brightness of title bars 22a-c is indicated by hatching on the drawing. For example, title bar 22a “CLASSICS” has no hatching and displayed as the brightest bar, and has the highest hierarchical level among the title bars. On the other hand, title bar 22c with double hatching has the lowest hierarchical level among the title bars. The differences in brightness of the bars can be achieved by rendering a graphic image by graphic image rendering component 22 based on the syntax analysis of the meta data performed by syntax analysis component 24.

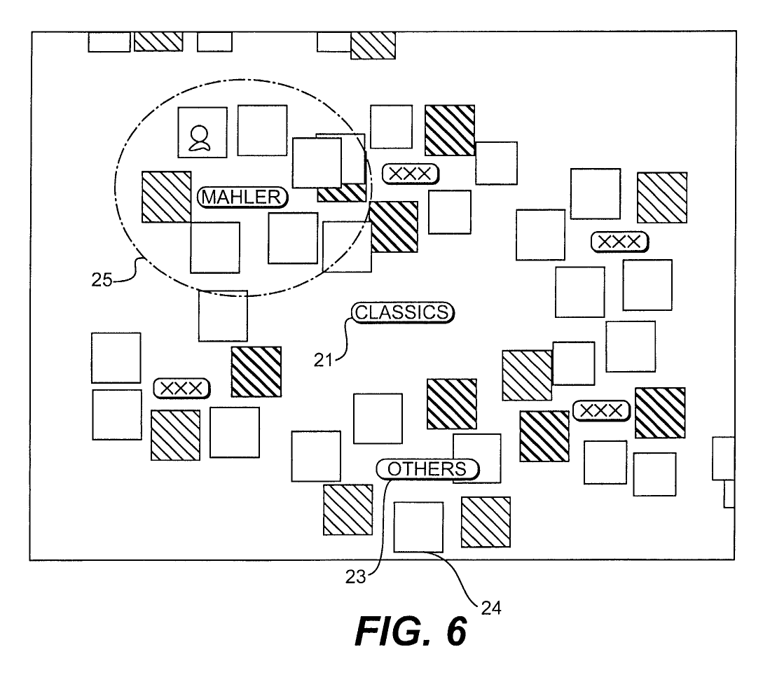

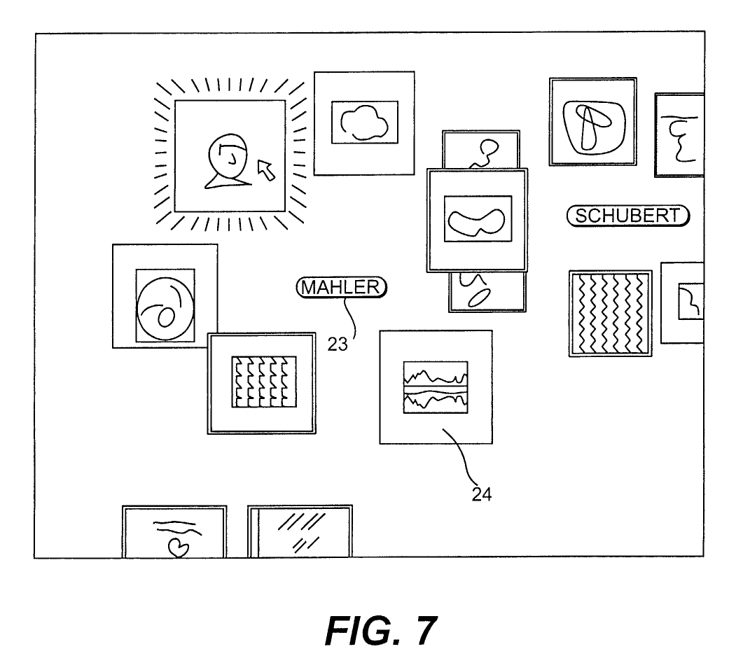

A user can click operation button 26 (Step S.42) to bring, for example, title bar 22a “CLASSICS” in the far most front on selection screen 20 (Step S.44). The user then clicks a zoom-in button in operation button 26 to zoom in a desired composer of “CLASSICS.” When the user clicks desired composer's name 23, for example, MAHLAR (Step S.46), a group of CD productions of MAHLAR are zoomed in (Step S.48) and displayed on an enlarged scale (see FIG. 6). Subsequently, the user may select a desired CD by clicking its jacket pattern (Step S.50), as shown in FIG. 7.

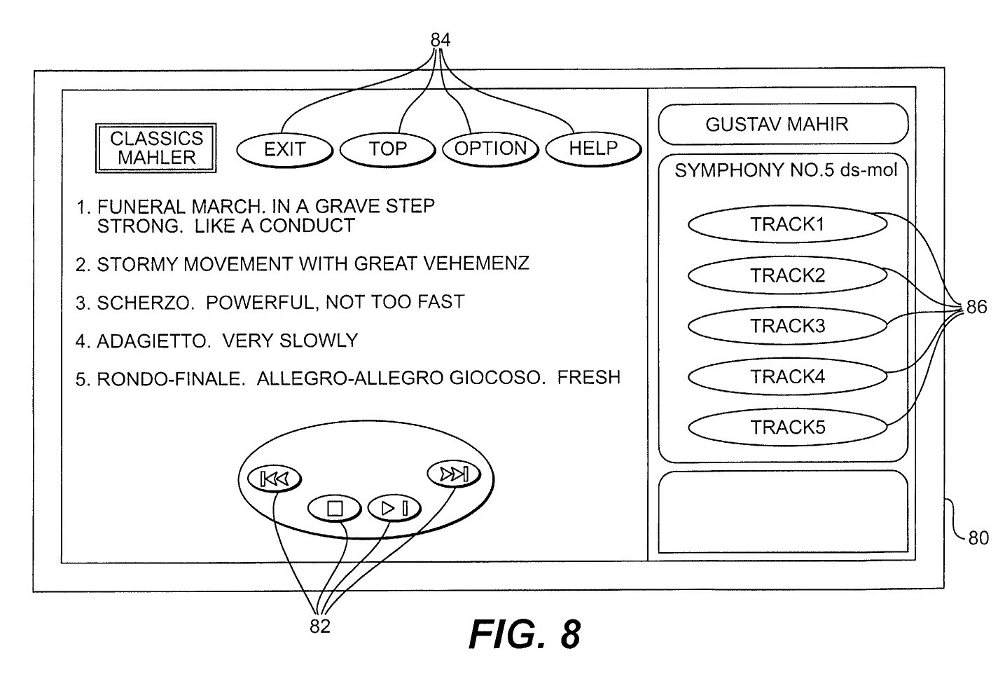

In one preferred embodiment, when the user clicks a jacket pattern of the desired CD, a listening screen 80, as shown in FIG. 8, may appear on the screen display (Step S.52). Listening screen 80 includes buttons 82 for play, stop, skip, playback, and other functions typically seen on CD players. Listening screen 80 may also include buttons 84 to manipulate the display, such as exit, option, on the like, and buttons 84 to select a music track to facilitate listening of a CD. The user can then listen to a music contained in the CD from this listening screen (Step S.54).

The index information display component for CDs may also include network communication component 8, as shown in FIG. 2, to allow users to search for a desired CD via the Internet or other similar network. In another embodiment, the component includes accounting device 9 illustrated in FIG. 2. Accounting device 9 can calculate and bill access or service fees or the purchase price of the CD to the users. Additionally, a purchase button that links to the accounting device may be provided on the display screen to automate the purchase operation.

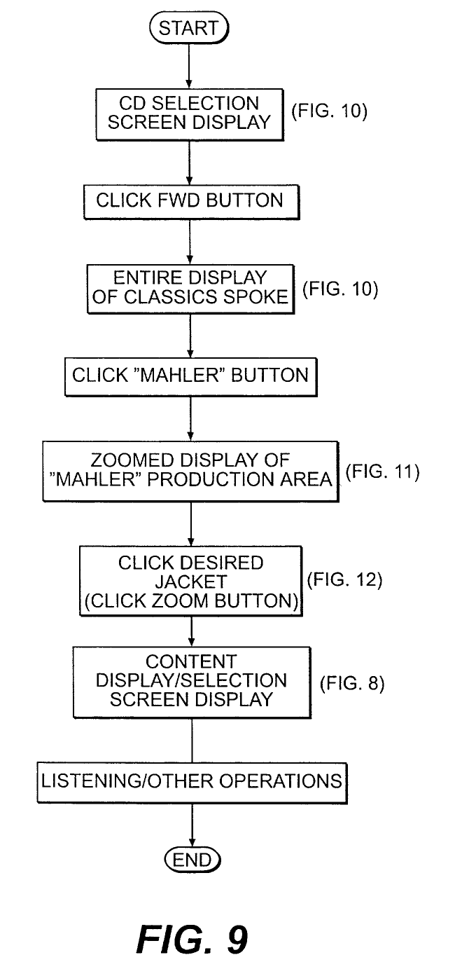

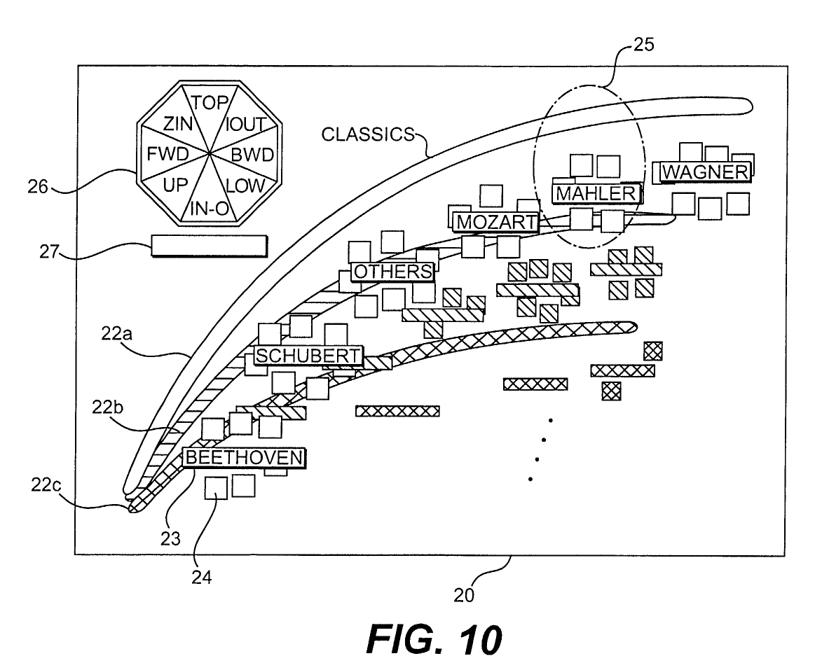

FIG. 9 illustrates a flow chart of the operation procedure of an index information display system and method for searching a music CD according to another embodiment of the invention. FIGS. 10-12 illustrate a graphic display in accordance with the system and method. As shown in FIG. 9, a search for a music CD starts from a display of a CD selection screen (Step S.90). One example of the CD selection screen is illustrated in FIG. 10. As shown in FIG. 10, CD selection screen 20 displays a title 21, “MUSIC,” and a plurality of genre names 22, for example, CLASSICS, ROCKS, and POPS, as subtitles. In the vicinity of each genre name 22, names of composers and musicians 23 and a plurality of CD jacket graphic images 24 by each composer or musician are displayed as a composition group 25. In one preferred embodiment, composition groups 25 may be arranged such that, for example, ones having similar style of music are located closely. Moreover, CD jacket graphic images 24 may be displayed according to the order of popularity or in the chronological order. For example, the jacket of the most popular CD can be displayed over the other CD jackets to illustrate the hierarchical relationship among CD jackets. As the number of displayed CD jackets increases, the jackets may be displayed, according to their popularity, toward the back of the display screen view.

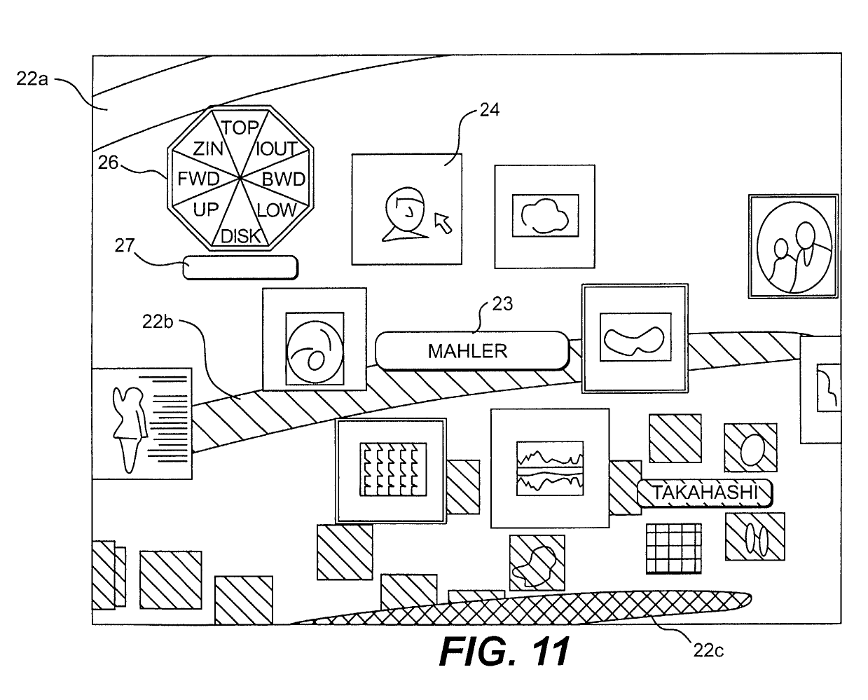

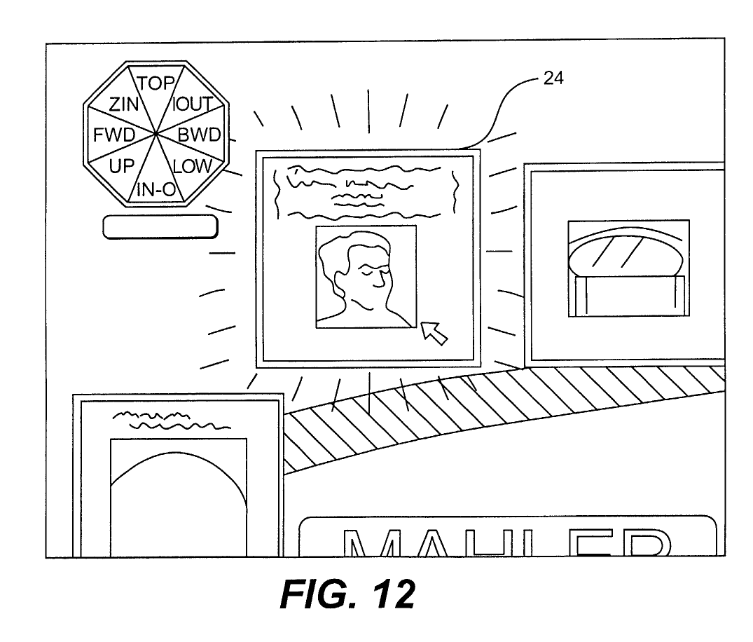

When a user clicks a “CLASSICS” button on selection screen 50 (Step S.92), the graphic image area of the “CLASSICS” group may be zoomed (Step S.94), as shown in FIG. 11. When the user subsequently clicks a button for a desired composer, for example “MAHLAR,” (Step S.96), a group of CD productions of MAHLAR are zoomed and displayed, (Step S.98), as shown in FIG. 12.

When the user clicks a desired CD production of MAHLER (Step S.100), a listening screen, as shown in FIG. 8 is displayed (Step S.102). With the listening screen, the user can listen to music contained in the selected CD (Step S.104).

Exemplary meta data used for this index information display system for searching a music CD is described as follows:

Name:“Symphony_No5.vain”

Place:“http://www.wellstone.co.jp/VAIN/music.vain/classic.vain/Mahlar.vain/ Symphony_No5.vain”

Class:“http://www.wellstone.co.jp/VAIN/music.vain/classic.vain/Mahlar.vain”

Position: “12,134,55”

The above meta data is interpreted as follows:

The name of the information is “Symphony/No5.vain” and the suffix “.vain” indicates that the information contains data to render a graphic image. The information for the graphic image is located at “http://www.wellstone.co.jp/VAIN/music.vain/classic.vain/Mahlar.vain/Symphony_No5.vain”. This information belongs to a hierarchical level of “http://www.wellstone.co.jp/VAIN/music.vain/classic.vain/Mahlar.vain.” Though the information in the meta data is described in the World Wide Web application in this example, the location and hierarchical level is not limited to the World Wide Web application. For example, the information may be stored in a hard disk drive in a personal computer or a CD. The coordinate of the hierarchical group for the information is “12,134,55”. This coordinate indicates a display location of the information in three-dimensional reference points.

Once the meta data is set for the information to be displayed on a screen, the data can be stored in meta data storage component 25. The meta data can be edited at later time by hierarchy/correlation data setting-editing component 26.

The stored meta data is analyzed by syntax analysis component 24 and generates a set of rendering instructions. These instructions includes how a graphic image should be created by graphic image component 22, including the degree of brightness, chroma and sizes, a three-dimensional shading or any other graphic effects. With the rendering instructions and the data stored in data storage component 23, graphic image rendering component creates graphic images of the information that has graphical effects to indicate hierarchical and correlative relationships of the information for users to view in its entirety. The graphical effects to indicate hierarchical and correlative relationships of the information may involve mathematical calculation based on a camera-light angle in a three-dimensional model. When a use clicks mouse to select a certain reference point to view the displayed information, the graphic effects of the information can be calculated according to the reference point to display the information with new graphical effects. Thus, the invention involves dynamic changes in a three-dimensional modeling. Even when a reference point and graphical effects are changed, the hierarchical and correlative relationship of the information is preserved so that the displayed information is always organized to a certain order.

In the exemplary embodiment of the invention, the index information display system for a music CD has been described. The invention, however, is not limited to music CDs and may be used to index information related to other products or services, as well as other types of information (news, weather, financial information, sports, etc.) Further, it will be apparent to those skilled in the art that various modifications and variations can be made in the method and system for displaying index information of the present invention without departing from the scope or spirit of the invention. Other embodiments of the invention will be apparent to those skilled in the art from consideration of the specification and practice of the invention disclosed herein. In addition, the features of the various embodiments disclosed herein may be combined, substituted or integrated in accordance with the principles hereof. Therefore, it is intended that the specification and examples be considered as exemplary only, with a true scope and spirit of the invention being indicated by the following claims.

We claim:

1. A system for providing index information, the system comprising:
a hierarchy/correlation data device for setting and editing hierarchy data and correlation data;
a meta data storage device for storing the edited and set index information as meta data;
a syntax analysis device for analyzing the meta data and generating a set of rendering instructions;
a graphic image rendering device for rendering a graphic image based on the analyzed meta data and set of rendering instructions; and
a display device for displaying the rendered graphic image.

2. The system of claim 1, further including a graphic-image-data storage device coupled to the graphic image rendering device, the graphic-image-data storage device having graphic image rendering data.

3. The system of claim 1, further including a coordinate detection device coupled to the graphic image rendering device for setting a coordinate for the rendered graphic image on the display device.

4. The system of claim 1, further including a display control unit coupled to the display device and the graphic image rendering device for controlling the rendering graphic image display.

5. The system of claim 1, wherein the graphic image rendering device renders a plurality of graphic images.

6. The system of claim 5, wherein the plurality of graphic images have different sizes.

7. The system of claim 5, wherein the plurality of graphic images have different chroma.

8. The system of claim 5, wherein the plurality of graphic images have different brightness.

9. A multi-level information index display method, including the steps of:
setting and editing multi-level hierarchical and correlated information;
storing the information as meta data;
analyzing the meta data and generating a set of rendering instructions;
rendering a graphic image based on the analyzed meta data and set of rendering instructions; and
displaying the graphic image for a user to view.

10. The method of claim 8, further including a step of providing graphic image rendering data to render the graphic image.

11. The method of claim 8, further including a step of setting a coordinate for the graphic image on the display device.

12. The method of claim 8, further including a step of controlling the display of the graphic image display.

13. The method of claim 8, wherein the display step includes a step of displaying a plurality of graphic images.

14. The method of claim 13, wherein the plurality of graphic images have different sizes.

15. The method of claim 13, wherein the plurality of graphic images have different chroma.

16. The method of claim 13, wherein the plurality of graphic images have different brightness.

17. A method for displaying an item among a group of items to users, comprising the steps of:
setting and editing multi-level hierarchical and correlated information of each of the group of items;
storing the information as meta data;
analyzing the meta data and generating a set of rendering instructions;
rendering a graphic image based on the analyzed meta data and set of rendering instructions; and
displaying the graphic image for each of the group of items for a user to view.

18. The method of claim 17, further including a step of providing graphic image rendering data to render the graphic image.

19. The method of claim 17, further including a step of setting a coordinate for the graphic image on the display device.

20. The method of claim 17, further including a step of controlling the display of the graphic image display.

21. The method of claim 21, wherein the graphic images have different sizes.

22. The method of claim 21, wherein the graphic images have different chroma.

23. The method of claim 21, wherein the graphic images have different brightness.

24. The method of claim 17, further including a step of manipulating the graphic image display.

25. The method of claim 17, further including a step of purchasing the item among the group of items by selecting from the item from the group of items on the display.

26. The method of claim 25, further including a step of calculating a purchase price of the item.

27. The method of claim 17, further including a step of calculating access fee.

28. The method of claim 17, further including a step of providing the group of items to the users via network.

29. A method for displaying a graphic image, comprising the steps of:
setting meta data to information, the meta data including hierarchical and correlated information;
analyzing the meta data; and
rendering the graphic image based on the analyzed meta data, the graphic image having a graphic effect according to the hierarchical and correlated information.

30. The method of claim 29, wherein the graphic effect is mathematically determined from the meta data.

31. The method of claim 29, wherein the graphic effect includes at least one of three-dimensional shading, brightness, chroma and size.

32. The method of claim 29, wherein the graphic effect is dynamically changed based on the hierarchical and correlated information.

33. A method for displaying graphic images in a hierarchical and correlated manner, comprising the steps of:
setting meta data to information, the meta data being an index information to display the information in a hierarchical and correlated relationship;
analyzing the meta data;
rendering the graphic images in the hierarchical and correlated relationship based on the analyzed meta data; and
displaying the graphic images in the hierarchical and correlated relationship for users to view the graphic images collectively.

34. The method of claim 33, wherein the displayed graphics images is collectively displayed with the hierarchical and correlated relationship indicated by at least one of three-dimensional shading, brightness, chroma and size.

35. A method for displaying a graphic image of an index information, the graphic image having a three-dimensional graphic effect, comprising the steps of:
providing a meta data to the index information, the meta data including hierarchical and correlated information;
analyzing the meta data; and
rendering the graphic image having the three-dimensional graphic effect based on the analyzed meta data, the graphic effect being mathematically determined from the meta data.

36. The method of claim 35, wherein the graphic effect includes at least one of three-dimensional shading, brightness, chroma and size.

37. The method of claim 35, wherein the graphic effect is dynamically changed based on the hierarchical and correlated information.
